(19) United States
(12) Patent Application Publication
(10) Pub. No.: US 2025/0338198 A1
(43) Pub. Date: Oct. 30, 2025

(54) METHOD, DEVICE AND COMPUTER STORAGE MEDIUM OF COMMUNICATION

(71) Applicant: NEC Corporation, Tokyo (JP)

(72) Inventors: Zonghui XIE, Beijing (CN); Gang WANG, Beijing (CN)

(73) Assignee: NEC Corporation, Tokyo (JP)

(21) Appl. No.: 18/868,566

(22) PCT Filed: May 25, 2022
(86) PCT No.: PCT/CN2022/095026

§ 371 Date: Nov. 22, 2024

(51) Int. Cl. H04W 36/32

(52) U.S. Cl. CPC H04W 36/322

(57) ABSTRACT

Embodiments of the present disclosure relate to methods, devices and computer readable media for communication. A terminal device determines whether the terminal device is approaching an out-of-coverage area based on a period of time before the terminal device enters the out-of-coverage area. If the terminal device is approaching the out-of-coverage area, the terminal device transmits first information indicating that the terminal device is approaching the out-of-coverage area. In this way, a terminal device may assist a network to handle discontinuous coverage situation. Unnecessary power consumption due to excessive failures or recovery actions may be avoided.

### FIELD

Embodiments of the present disclosure generally relate to the field of telecommunication, and in particular, to methods, devices and computer storage media of communication for discontinuous coverage situation.

### BACKGROUND

As known, a non-terrestrial network (NTN) is proposed to provide wide area coverage. A NTN refers to networks or segments of networks using an airborne or space-borne vehicle to embark a transmission equipment relay node or base station or using radio frequency (RF) resources on board a satellite or unmanned aerial system (UAS) platform. As a satellite moves on a specified orbit, coverage area of the satellite may move and cover different portions of a geographical area. As a consequence, a terminal device located in a concerned geographical area may experience a situation of discontinuous coverage, due to e.g. a sparse satellites constellation deployment. Currently, it is highly concerned how to enable the terminal device to save power during periods of no coverage.

### SUMMARY

In general, embodiments of the present disclosure provide methods, devices and computer storage media of communication for discontinuous coverage situation.

In a first aspect, there is provided a method of communication. The method comprises: determining, at a terminal device, whether the terminal device is approaching an out-of-coverage area based on a period of time before the terminal device enters the out-of-coverage area; and in accordance with a determination that the terminal device is approaching the out-of-coverage area, transmitting first information indicating that the terminal device is approaching the out-of-coverage area.

In a second aspect, there is provided a method of communication. The method comprises: receiving, at an access network device, first information indicating that a terminal device is approaching an out-of-coverage area; and performing an operation based on the first information.

In a third aspect, there is provided a terminal device. The device comprises a processor configured to perform the method according to the first aspect of the present disclosure.

In a fourth aspect, there is provided an access network device. The device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

Through the more detailed description of some embodiments of the present disclosure in the accompanying drawings, the above and other objects, features and advantages of the present disclosure will become more apparent, wherein:

FIG. 1 illustrates an example communication environment in which some embodiments of the present disclosure can be implemented;

FIG. 2 illustrates a schematic diagram illustrating a process for reporting coverage hole information in a connected state according to embodiments of the present disclosure;

FIG. 3 illustrates a schematic diagram illustrating an angle between a moving direction of a NTN node and a connecting line between a terminal device and a reference point according to embodiments of the present disclosure;

FIG. 4 illustrates a schematic diagram illustrating a process for reporting coverage hole information in a timing advance (TA) report in according to embodiments of the present disclosure;

FIG. 5A illustrates a schematic diagram illustrating an example MAC CE for reporting coverage hole information according to embodiments of the present disclosure;

FIG. 5B illustrates a schematic diagram illustrating another example MAC CE for reporting coverage hole information with TA information according to embodiments of the present disclosure;

FIG. 6A illustrates a schematic diagram illustrating a process for reporting coverage hole information in a random access (RA) procedure according to embodiments of the present disclosure;

FIG. 6B illustrates a schematic diagram illustrating another process for reporting coverage hole information in a RA procedure according to embodiments of the present disclosure;

FIG. 6C illustrates a schematic diagram illustrating a process for reporting coverage hole information in a preconfigured uplink resource (PUR) transmission according to embodiments of the present disclosure;

FIG. 6D illustrates a schematic diagram illustrating another process for reporting coverage hole information in a PUR transmission according to embodiments of the present disclosure;

FIG. 7 illustrates a schematic diagram illustrating a process for PUR management according to embodiments of the present disclosure;

FIG. 8 illustrates an example method of communication implemented at a terminal device in accordance with some embodiments of the present disclosure;

FIG. 9 illustrates an example method of communication implemented at an access network device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “core network (CN) device” refers to any device or entity that provides access and mobility management function, session management function (SMF), user plane function (UPF), etc. By way of example rather than limitation, the CN device may be a mobility management entity (MME), an AMF, a SMF, a UPF, etc. In other embodiments, the CN device may be any other suitable device or entity.

As used herein, the term “access network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As discussed above, the NTN is capable of providing wide network coverage. Currently, there may be different types of satellite (or UAS platform) in the NTN. Blow Table 1 illustrated the example types of satellite.

TABLE 1
Example Types of satellite/UAS platform

| | | | | Typical | |
|---|---|---|---|---|---|
| | | | | beam | |
| | | | | footprint | |
| Satellite/UAS Platforms | Altitude range | | Orbit | size | |
| Low-Earth Orbit (LEO) satellite | 300-1500 | km | Circular around the earth | 100-1000 | km |
| Medium-Earth Orbit (MEO) | 7000-25000 | km | | 100-1000 | km |
| satellite | | | | | |
| Geostationary Earth Orbit | 35 786 | km | notional station keeping | 200-3500 | km |
| (GEO) satellite | | | position fixed in terms of | | |
| UAS platform (including | 8-50 km (20 km | | elevation/azimuth with | 5-200 | km |
| HAPS) | for HAPS) | | respect to a given earth | | |
| | | | point | | |
| High Elliptical Orbit | 400-50000 | km | Elliptical around the earth | 200-3500 | km |

(HEO) satellite

Further, the NTN typically features the following elements:
One or several sat-gateways that connect the NTN to a public data network;
   A GEO satellite is fed by one or several sat-gateways which are deployed across the satellite targeted coverage (e.g. regional or even continental coverage). We assume that UE in a cell are served by only one sat-gateway;
   A Non-GEO satellite served successively by one or several sat-gateways at a time. The system ensures service and feeder link continuity between the successive serving sat-gateways with sufficient time duration to proceed with mobility anchoring and hand-over.
A feeder link or radio link between a sat-gateway and the satellite (or UAS platform).
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
   A transparent payload: radio frequency filtering, frequency conversion and amplification. Hence, the waveform signal repeated by the payload is un-changed;
   A regenerative payload: radio frequency filtering, frequency conversion and amplification as well as demodulation/decoding, switch and/or routing, coding/modulation. This is effectively equivalent to having all or part of base station functions (e.g., gNB) on board the satellite (or UAS platform).
Inter-satellite links (ISL) optionally in case of a constellation of satellites. This will require regenerative payloads on board the satellites. ISL may operate in RF frequency or optical bands.
UEs are served by the satellite (or UAS platform) within the targeted service area.

Currently, The NTN has been developed to support scenarios of IoT and enhanced machine type communication (eMTC). Examples of IoT NTN are listed as below.
Scenario A: GEO based non-terrestrial access network;
Scenario B: LEO based non-terrestrial access network generating steerable beams, (altitude 1200 km and 600 km), the steerable beams generating one or more earth fixed cells;
Scenario C: LEO based non-terrestrial access network generating fixed beams whose footprints move with the satellite (altitude 1200 km and 600 km), the fixed beams generating one or more earth moving cells; and
Scenario D: MEO based non-terrestrial access network generating fixed beams whose footprints move with the satellite (altitude 10000 km), the fixed beams generating one or more earth moving cells.

As a satellite moves on a specified orbit, for example in case of a Non-GEO satellite, coverage area of the satellite may move and cover different portions of a geographical area due to the orbital movement of the satellite. As a consequence, UE located in a concerned geographical area may experience a situation of discontinuous coverage, due to e.g. a sparse satellites constellation deployment.

To enable the UE to save power during periods of no coverage, a network may provide satellite mean ephemeris parameters to enable the UE to predict when coverage will be provided by upcoming satellites. Predicting out of coverage and in coverage using the satellite mean ephemeris is up to UE implementation. When out of coverage, the UE is not required to perform access stratum (AS) functions.

However, in the discontinuous coverage situation, the UE may perform excessive failures or recovery actions (i.e., experiencing radio link failure (RLF) recovery), and the network may also try to reach UEs that are out of coverage (i.e., paging), which lead to excessive power consumption for both UE and network.

In view of this, embodiments of the present disclosure provide a solution for communication so as to solve the above and other potential problems. In this solution, a terminal device determines whether the terminal device is approaching an out-of-coverage area based on a period of time before the terminal device enters the out-of-coverage area. If the terminal device is approaching the out-of-coverage area, the terminal device transmits information (for convenience, also referred to as first information herein) indicating that the terminal device is approaching the out-of-coverage area.

In this way, a terminal device may assist a network to handle discontinuous coverage situation. Unnecessary power consumption due to excessive failures or recovery actions may be avoided.

Principle and example embodiments of the present disclosure will be described in detail below with reference to the accompanying drawings.

In the following, a satellite will be used as an example of an access network device for describing some specific example embodiments of the present disclosure. It is noted that example embodiments described with regard to the satellite are equally applicable to any other suitable types of an access network device.

In the context of the present application, the wording “an access network device moves” or similar wording refers to a satellite associated with the access network device moves.

### Example of Communication Network

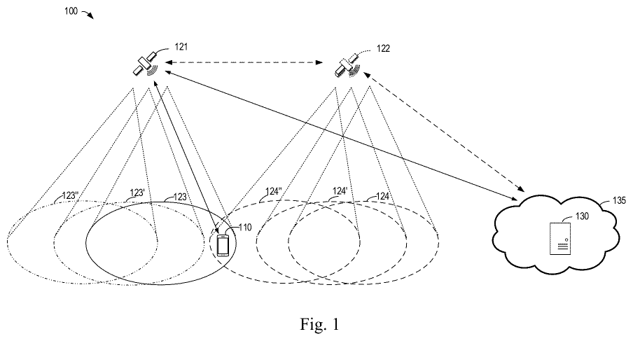

FIG. 1 shows an example communication environment 100 in which example embodiments of the present disclosure can be implemented. The network environment 100 includes a terminal device 110 and an access network device 121 serving the terminal device 110 and an access network device 122. Additionally, one or more ISL may be established between the access network device 121 and the access network device 122.

Additionally, any of the access network devices 121 and 122 may provide one or more serving cells to the terminal device 110. In the example of FIG. 1, the access network device 121 provides a serving cell 123 and the access network device 122 provides a serving cell 124. For convenience, the following description will be given by assuming that the terminal device 110 is within the serving cell 123 of the access network device 121.

Further, the network environment 100 may comprise a gateway 135. The gateway 135 may comprise a plurality of network devices (such as, the CN device 130 as illustrated in FIG. 1). The plurality of network devices may implement any suitable functionality. For transparent payload scenario, the gateway 135 may also comprise other on-ground access network device.

In case that the terminal device 110 is within the serving cell 123 generated from the access network device 121 (i.e., the satellite), a service link refers to a radio link between the terminal device 110 and the access network device 121. A feeder link refers to a radio link between the access network device 121 and the gateway 135. Communication in a direction from a terminal device 110 towards the access network device 121 and further to the gateway 135 is referred to as uplink communication, while communication in a reverse direction from the access network device 121 towards the terminal device 110 is referred to as downlink communication.

In the example of FIG. 1, the terminal device 110 may be in different states (such as, connected state, inactive state and idle state) and also may operate on a power saving mechanism including but not limited to DRX, eDRX, PSM, relaxed monitoring and so on.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of access network device, terminal device, CN device, CN and serving cell are only for the purpose of illustration without suggesting any limitations. The communication environment 100 may include any suitable access network device, terminal device, CN device, CN and serving cell adapted for implementing embodiments of the present disclosure. Although not shown, it is to be understood that one or more additional network devices may comprised in communication environment 100, such as, a terrestrial station, a gateway and so on.

In some scenarios, the terminal device 110 and/or the access network device 121 may move over time. When moving, the terminal device 110 may be located in different serving cells and also may be out of the coverage of the network sometimes. For example, it is assumed that the terminal device 110 is stationary. As shown in FIG. 1, as the access network devices 121 and 122 move (for example, on a specified orbit), coverage area of the cell 123 provided by the access network device 121 may move to cover geographical area 123′ and coverage area of the cell 124 provided by the access network device 122 may move to cover geographical area 124′. In this case, the terminal device 110 is not in any coverage area of cells. That is, the terminal device 110 is in an out-of-coverage area (also referred to as a coverage hole herein). As the access network devices 121 and 122 further move (for example, on a specified orbit), coverage area of the cell 123 provided by the access network device 121 may move to cover geographical area 123″ and coverage area of the cell 124 provided by the access network device 122 may move to cover geographical area 124″. In this case, the terminal device 110 is in coverage area of the cell 124. That is, the terminal device 110 is in coverage area of a neighbor cell. These scenarios may be called as discontinuous coverage situations.

Embodiments of the present disclosure provide a solution of handing the discontinuous coverage situations to save power consumption during periods of no coverage.

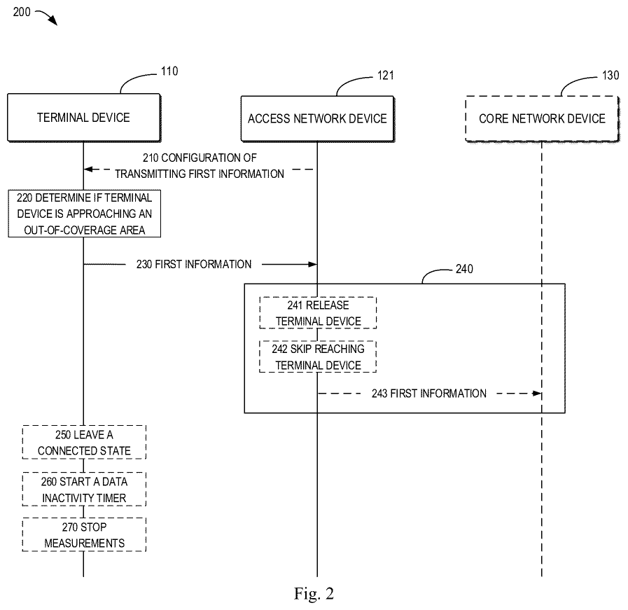

In the solution, if a terminal device is approaching an out-of-coverage area, the terminal device reports information (also called as first information) indicating that the terminal device is approaching the out-of-coverage area. In one aspect, embodiments of the present disclosure provide a mechanism of event triggered reporting of the first information in a connected state. In another aspect, embodiments of the present disclosure provide a mechanism of reusing a TA report to report the first information. In still another aspect, embodiments of the present disclosure provide a mechanism of reporting the first information during a RA procedure. More details will be described below in connection with FIGS. 2 to 6.

### Example Implementation of Event Triggered Reporting

FIG. 2 illustrates a schematic diagram illustrating a process 200 for reporting coverage hole information in a connected state according to embodiments of the present disclosure. For the purpose of discussion, the process 200 will be described with reference to FIG. 1. The process 200 may involve the terminal device 110 and the access network device 121 as illustrated in FIG. 1.

As shown in FIG. 2, the access network device 121 may transmit 210, to the terminal device 110, a configuration of transmitting the first information. For example, the access network device 121 may transmit a radio resource control (RRC) connection reconfiguration message indicating a reporting of the first information. It is to be understood that any other suitable messages are also feasible to indicate the reporting of the first information.

In some embodiments, the configuration may comprise an indication that reporting the first information is enabled, for example, in a RA procedure or in a connected state. In some embodiments, the configuration may comprise a threshold used for determination of whether the terminal device 110 is approaching an out-of-coverage area. In some embodiments, the configuration may comprise a timer for preventing a duplicate reporting of the first information. In some embodiments, the configuration may comprise an indication that triggering a scheduling request (SR) is enabled. It is to be understood that the configuration may also comprise any combination of the above and any other suitable information.

Alternatively, the reporting of the first information may be predefined. In this case, the access network device 121 may not transmit the configuration to the terminal device 110.

As shown in FIG. 2, the terminal device 110 may determine 220 whether the terminal device 110 is approaching an out-of-coverage area. In some embodiments, the terminal device 110 may determine whether the terminal device 110 is approaching the out-of-coverage area based on a period of time before the terminal device 110 enters the out-of-coverage area. In other words, the terminal device 110 may determine whether the terminal device 110 is approaching the out-of-coverage area based on a period of time for which the terminal device 110 is being served in coverage area of the cell 123.

In some embodiments, the terminal device 110 may determine the period of time based on GNSS positioning information of the terminal device 110 and information of movement of the access network device 121 over time (for example, Ephemeris). Upon determination of the period of time, both the relative location between the terminal device 110 and the access network device 121 and the movement trends of the access network device 121 (i.e., satellite orbit) may be considered. It is to be understood that the terminal device 110 may determine the period of time in any other suitable ways, and the present disclosure does not limit this aspect.

Upon determination of the period of time, the terminal device 110 may compare the period of time with a threshold. In some embodiments, the threshold may be predefined. In some embodiments, the threshold may be configured. In some embodiments, if the period of time is smaller than the threshold, the terminal device 110 may determine that the terminal device 110 is approaching the out-of-coverage area. In some embodiments, if the period of time is getting shorter, the terminal device 110 may determine that the terminal device 110 is approaching the out-of-coverage area. In some embodiments, if the period of time is greater than the threshold, the terminal device 110 may determine that the terminal device 110 is approaching the out-of-coverage area. In some embodiments, if the period of time is getting longer, the terminal device 110 may determine that the terminal device 110 is not approaching the out-of-coverage area. For example, the terminal device 110 is being away from the out-of-coverage area.

In some embodiments, if the period of time is equal to the threshold, the terminal device 110 may determine that the terminal device 110 is approaching the out-of-coverage area. In some embodiments, if the period of time is equal to the threshold, the terminal device 110 may determine that the terminal device 110 is not approaching the out-of-coverage area.

Alternatively, the terminal device 110 may determine whether the terminal device 110 is approaching the out-of-coverage area based on a distance between a reference point and the terminal device 110. In some embodiments, the reference point may be a location of a satellite. In some embodiments, the reference point may be a center of coverage (e.g., a center of the cell 123). In some embodiments, the reference point may be any location in coverage (e.g., any location in the cell 123). In some embodiments, the terminal device 110 may determine the distance based on GNSS positioning information of the terminal device 110 and Ephemeris information of the access network device 121. It is to be understood that the terminal device 110 may determine the distance in any other suitable ways, and the present disclosure does not limit this aspect.

Upon determination of the distance, the terminal device 110 may compare the distance with a threshold distance. In some embodiments, the threshold distance may be predefined. In some embodiments, the threshold distance may be configured. Take the center of coverage as an example of reference point. In some embodiments, if the distance is smaller than the threshold distance, the terminal device 110 may determine that the terminal device 110 is not approaching the out-of-coverage area. If the distance is greater than the threshold distance, the terminal device 110 may determine that the terminal device 110 is approaching the out-of-coverage area. In some embodiments, if the terminal device 110 is getting closer to the reference point, which is to say, the distance is decreased in past time period T, the terminal device 110 may determine that the terminal device 110 is not approaching the out-of-coverage area. In some embodiments, if the terminal device 110 is getting far away from the reference point, which is to say, the distance is increased in past time period T, the terminal device 110 may determine that the terminal device 110 is approaching the out-of-coverage area.

In some embodiments, if the distance is equal to the threshold distance, the terminal device 110 may determine that the terminal device 110 is approaching the out-of-coverage area. In some embodiments, if the distance is equal to the threshold distance, the terminal device 110 may determine that the terminal device 110 is not approaching the out-of-coverage area.

Alternatively, the terminal device 110 may determine whether the terminal device 110 is approaching the out-of-coverage area based on an angle between a moving direction of the access network device 121 and a connecting line between the terminal device 110 and a reference point. In some embodiments, when the terminal device 110 considers that the network has obtained valid timing advance (TA) of the terminal device 110, the terminal device 110 may determine whether the terminal device 110 is approaching the out-of-coverage area based on the angle.

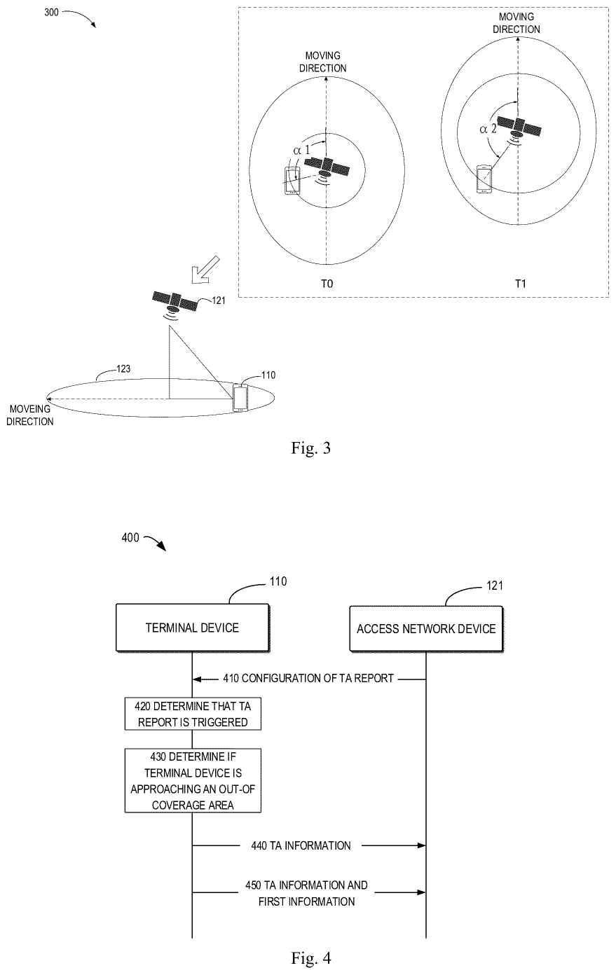

FIG. 3 illustrates a schematic diagram 300 illustrating an angle between a moving direction of a NTN node (e.g., the access network device 121) and a connecting line between a terminal device (e.g., the terminal device 110) and a reference point (e.g., a center of the cell 123) according to embodiments of the present disclosure. As shown in FIG. 3, the moving direction of the access network device 121 is represented by a ground projection of satellite moving orbit. At a timing T0, the moving direction and a connecting line between the terminal device 110 and the center of the cell 123 may form an angle α1. At a timing T1, the moving direction and the connecting line between the terminal device 110 and the center of the cell 123 may form an angle α2.

In some embodiments, the reference point may be a location of a satellite. In some embodiments, the reference point may be a center of coverage (e.g., a center of the cell 123). In some embodiments, the reference point may be any location in coverage (e.g., any location in the cell 123).

In some embodiments, the terminal device 110 may determine the angle based on GNSS positioning information of the terminal device 110 and Ephemeris information of the access network device 121. It is to be understood that the terminal device 110 may determine the angle in any other suitable ways, and the present disclosure does not limit this aspect.

Upon determination of the angle, the terminal device 110 may compare the angle with a threshold angle. In some embodiments, the threshold angle may be predefined. In some embodiments, the threshold angle may be configured. Take the center of coverage as an example of reference point. In some embodiments, if the angle is smaller than the threshold angle, the terminal device 110 may determine that the terminal device 110 is not approaching the out-of-coverage area. If the angle is greater than the threshold angle, the terminal device 110 may determine that the terminal device 110 is approaching the out-of-coverage area. In some embodiments, if the terminal device 110 is getting closer to the reference point, which is to say, the angle is decreased in past time period T, the terminal device 110 may determine that the terminal device 110 is not approaching the out-of-coverage area. In some embodiments, if the terminal device 110 is getting far away from the reference point, which is to say, the angle is increased in past time period T, the terminal device 110 may determine that the terminal device 110 is approaching the out-of-coverage area.

In some embodiments, if the angle is equal to the threshold angle, the terminal device 110 may determine that the terminal device 110 is approaching the out-of-coverage area. In some embodiments, if the angle is equal to the threshold angle, the terminal device 110 may determine that the terminal device 110 is not approaching the out-of-coverage area.

It is to be understood that the terminal device 110 may adopt any combination of the above and any other suitable ways to determine whether the terminal device 110 is approaching the out-of-coverage area. In some embodiments, the determination on whether the terminal device 110 is approaching the out-of-coverage area may be performed with a period. In some embodiments, the period may be configured. In some embodiments, the period may be predefined.

As shown in FIG. 2, if the terminal device 110 is approaching the out-of-coverage area, the terminal device 110 may transmit 230 the first information indicating that the terminal device 110 is approaching the out-of-coverage area.

In some embodiments, the first information may comprise an indication (for convenience, also referred to as a first indication herein) of approaching the out-of-coverage area. In some embodiments, the first information may comprise the period of time before the terminal device 110 enters the out-of-coverage area. In some embodiments, the first information may comprise time information on when the terminal device 110 is going to enter the out-of-coverage area. In some embodiments, the first information may comprise a period of time before the terminal device 110 enters coverage area of a neighbor cell (for example, the cell 124). In some embodiments, the first information may comprise time information on when the terminal device 110 is going to enter coverage area of a neighbor cell (for example, the cell 124). In some embodiments, the first information may comprise a duration for which the terminal device 110 is in the out-of-coverage area. In some embodiments, the first information may additionally comprise valid time corresponding to information. That is, the information is considered as being valid in the corresponding valid time.

In some embodiments, the first information may comprise an angle between a moving direction of the access network device 121 and a connecting line between the terminal device 110 and a reference point (e.g., a center of the cell 123). In some embodiments, when the terminal device 110 considers that the network has obtained valid TA of the terminal device 110, the terminal device 110 may cause the angle to be comprised in the first information.

In some embodiments, the first information may comprise a serving time range corresponding to the period of time. For example, the first information may indicate that the maximum serving time is greater than first threshold time. As another example, the first information may indicate that the maximum serving time is greater than the first threshold time and is smaller than second threshold time. As still another example, the first information may indicate that the maximum serving time is greater than the second threshold time. It is to be understood that these are merely examples, and the serving time range may adopt any other suitable forms.

It is also to be understood that the first information may also comprise any suitable combination of the above and any other suitable information.

In some embodiments, the terminal device 110 may transmit the first information via a medium access control (MAC) control element (CE). For example, a MAC entity of the terminal device 110 may instruct a multiplexing and assembly procedure to generate a coverage hole information MAC CE to report the first information if a coverage hole information reporting procedure determines that at least one coverage hole report has been triggered and not cancelled and if uplink-shared channel (UL-SCH) resources are available for a new transmission and the UL-SCH resources can accommodate the coverage hole information MAC CE plus its subheader as a result of logical channel prioritization. In some embodiments, upon reporting the first information by the MAC entity of the terminal device 110 successfully, the MAC entity may inform a RRC entity of the terminal device 110 that the reporting is completed. In some embodiments, upon initiating the report of the first information by the MAC entity of the terminal device 110, the MAC entity may inform a RRC entity of the terminal device 110 that the reporting is completed.

In some embodiments, the terminal device 110 may receive, from the access network device 121, an indication indicating that triggering a SR is enabled for the transmission of the first information. In these embodiments, if no resources are available for the transmission of the first information, the terminal device 110 may trigger a SR. For example, a MAC entity of the terminal device 110 may trigger a SR if no UL-SCH resources are available for a new transmission or the UL-SCH resources cannot accommodate the coverage hole information MAC CE plus its subheader as a result of logical channel prioritization and if triggered SR by coverage hole information is configured with value enabled.

Alternatively, the terminal device 110 may transmit the first information via a RRC message. In some embodiments, the terminal device 110 may transmit the first information via UE assistance information (UAI). For example, upon initiating a coverage hole information reporting procedure, the terminal device 110 may start timer Timer A with the timer value set to the approachingCoverageHoleProhibitTimer and initiate transmission of the UAI if the terminal device 110 is configured to report coverage hole information and if approaching coverage hole has been detected and Timer A is not running. In some embodiments, the terminal device 110 may transmit the first information via a measurement report. For example, upon triggering of measurement event corresponding to approaching an out-of-coverage area, the terminal device 110 may transmit a measurement report. It is to be understood that any other suitable RRC messages are also feasible.

Continue to refer to FIG. 2, upon reception of the first information, the access network device 121 may perform 240 an operation based on the first information. In some embodiments, the access network device 121 may release 241 the terminal device 110 before the terminal device 110 enters the out-of-coverage area. In this way, a network may release a terminal device approaching an out-of-coverage area on time, and thus resource utilization efficiency may be improved.

In some embodiments, the access network device 121 may skip 242 reaching the terminal device 110 when the terminal device 110 is in the out-of-coverage area. In some embodiments, the access network device 121 may transmit 243, to the CN device 130, assistance information based on the first information. In this way, a network may avoid unnecessary power consumption due to unnecessary paging.

In some embodiments, upon transmission of the first information, if a RLF is detected, the terminal device 110 may leave 250 a connected state. For example, upon detection of RLF (expiry of timer T310), if coverage hole information indicating approaching a coverage hole has been reported to the access network device 121, the terminal device 110 may perform actions upon leaving a connected state (RRC_CONNECTED), without initiating cell searching or further re-establishment to the current serving cell or a new cell. In this way, the terminal device 110 may avoid unnecessary power consumption due to RLF recovery.

In some embodiments, upon transmission of the first information, the terminal device 110 may start 260 a data inactivity timer having a value smaller than a threshold value. In other words, the terminal device 110 may use a data inactivity timer with the value shorter than the one used before transmitting the first information. In some embodiments, the data inactivity timer may be configured by the access network device 121. In some embodiments, the value of the data inactivity timer may be determined by the terminal device 110 based on the one used before transmitting the first information and a configured scaling factor. In this way, the terminal device 110 may avoid unnecessary power consumption due to maintaining a connected state.

In some embodiments, upon transmission of the first information, the terminal device 110 may stop 270 at least one of intra-frequency measurements or inter-frequency measurements. In some embodiments where the terminal device 110 is a NB-IoT terminal device, if the terminal device 110 has not previously report coverage hole information to the current serving cell, the terminal device 110 will further decide to perform intra-frequency measurements or inter-frequency measurements based on at least one of the serving cell quality and the variance of serving cell quality. For example, if the terminal device 110 has not previously report coverage hole information to the current serving cell, and if neighCellMeasCriteria is not present in SystemInformationBlockType3-NB or a timer T326 is running, the terminal device 110 may decide to perform intra-frequency measurements or inter-frequency measurements based on the serving cell quality. In some embodiments where the terminal device 110 is an eMTC terminal device, if the UE is not in NE-DC and the PCell RSRP, after layer 3 filtering, is lower than s-Measure, or if the UE is in NE-DC and the PSCell RSRP, after layer 3 filtering, is lower than s-Measure, the terminal device 110 may perform corresponding measurements of neighbouring cells on the frequencies and RATs indicated in the concerned measObject if the terminal device 110 has not previously report coverage hole information to the current serving cell. In this way, the terminal device 110 may avoid unnecessary power consumption due to neighbor cell measurement, especially when there is no neighbor cell in discontinuous coverage scenario. In some embodiments, upon transmission of the first information, the terminal device 110 may also stop other unnecessary actions in connected state, for example, the evaluation of a TA reporting event.

With the process 200, information of approaching an out-of-coverage area may be transmitted in a connected state. In this way, a terminal device may assist a network to handle discontinuous coverage situation. Unnecessary power consumption due to excessive failures or recovery actions may be avoided.

### Example Implementation of Reporting in TA Report

FIG. 4 illustrates a schematic diagram illustrating a process 400 for reporting coverage hole information in a TA report according to embodiments of the present disclosure. For the purpose of discussion, the process 400 will be described with reference to FIG. 1. The process 400 may involve the terminal device 110 and the access network device 121 as illustrated in FIG. 1.

As shown in FIG. 4, the access network device 121 may transmit 410, to the terminal device 110, a configuration of a TA report.

The terminal device 110 may determine 420 whether a variation between current information about TA and the last successfully reported information about TA is equal to or larger than a threshold variation (e.g., offsetThresholdTA). If the variation is equal to or larger than the threshold variation, the terminal device 110 may determine that information of TA is to be reported. That is, a TA report is to be triggered.

In response to determining that information of TA is to be reported, the terminal device 110 may determine 430 whether the terminal device 110 is approaching an out-of-coverage area. The operation of determination 430 is similar to the operation of the determination 220 in FIG. 2, and thus is not repeated here for concise.

Continue to refer to FIG. 4, if the terminal device 110 is not approaching the out-of-coverage area, the terminal device 110 may report 440 the information of TA.

If the terminal device 110 is approaching the out-of-coverage area, the terminal device 110 may transmit 450 the information of TA and first information indicating the terminal device 110 is approaching the out-of-coverage area. The first information may be designed in a similar way as that described above in connection with FIG. 2 and thus is not repeated here for concise.

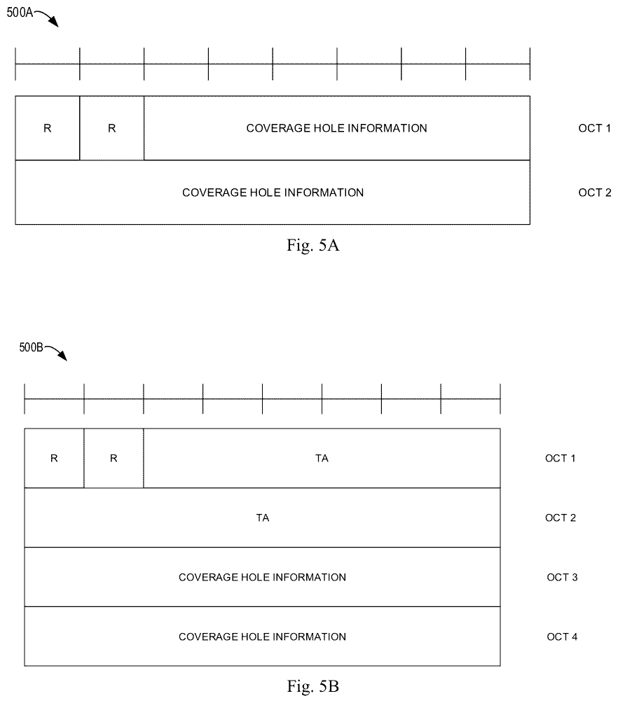

In some embodiments, the terminal device 110 may transmit the first information independently from the information of TA. FIG. 5A illustrates a schematic diagram illustrating a MAC CE 500A for a coverage hole information (e.g., the first information) reporting according to embodiments of the present disclosure. As shown in FIG. 5A, the coverage hole information may be carried in the MAC CE 500A dedicated for reporting the coverage hole information. In some embodiments, the first information and the information of TA may be transmitted separately. In some embodiments, the first information may be transmitted instead of the information of TA.

In some embodiments, the terminal device 110 may transmit the first information with the information of TA. FIG. 5B illustrates a schematic diagram illustrating another MAC CE 500B for a coverage hole information (e.g., the first information) reporting according to embodiments of the present disclosure. As shown in FIG. 5B, the coverage hole information may be carried in the MAC CE 500B for reporting the information of TA.

It is to be understood that FIGS. 5A and 5B are merely examples, and any other suitable ways are also feasible to carry the first information.

With the process 400, information of approaching an out-of-coverage area may be transmitted in a TA report. In this way, a terminal device may also assist a network to handle discontinuous coverage situation. Unnecessary power consumption due to excessive failures or recovery actions may also be avoided.

### Example Implementation of Reporting in RA Procedure

In some embodiments, coverage hole information may be reported during a RA procedure. This will be described in detail in connection with Embodiments 1 to 4.

### EMBODIMENT 1

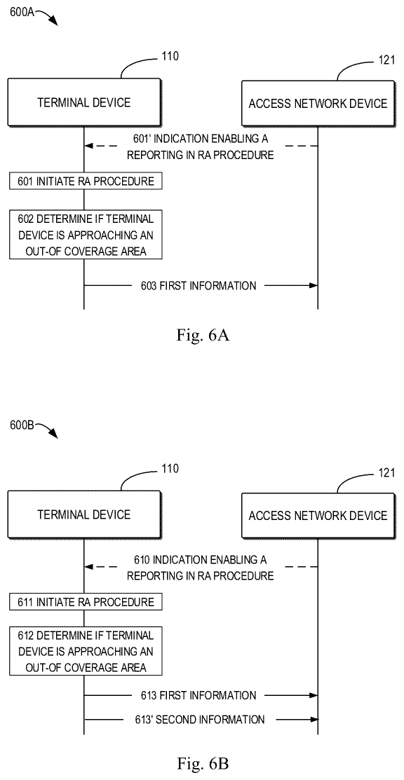

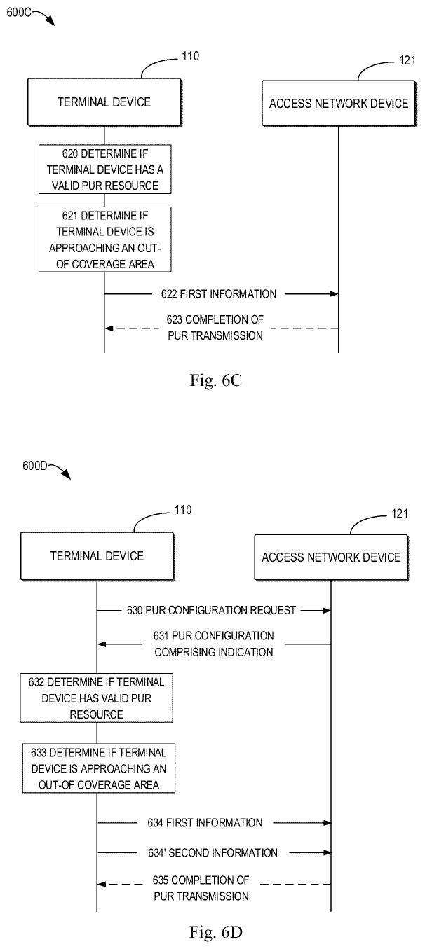

In this embodiment, information of approaching an out-of-coverage area may be reported during a RA procedure. For illustration, this embodiment will be described with reference to FIG. 6A. FIG. 6A illustrates a schematic diagram illustrating a process 600A for reporting coverage hole information in a RA procedure according to embodiments of the present disclosure. For the purpose of discussion, the process 600A will be described with reference to FIG. 1. The process 600A may involve the terminal device 110 and the access network device 121 as illustrated in FIG. 1.

As shown in FIG. 6A, the access network device 121 may transmit 601′, to the terminal device 110, an indication indicating that a coverage hole information reporting in a random access procedure is enabled. That is, the terminal device 110 is enabled to report whether the terminal device 110 is approaching an out-of-coverage area. Alternatively, the coverage hole information reporting may be predefined, and the access network device 121 may not transmit the indication.

The terminal device 110 may initiate 601 a RA procedure. For example, the terminal device 110 may transition from an idle or inactive state to a connected state.

In response to initiating the RA procedure, the terminal device 110 may determine 602 whether the terminal device 110 is approaching an out-of-coverage area. The operation of the determination 602 is similar to the operation of the determination 220 as described above in connection with FIG. 2, and thus is not repeated here for concise.

Continue to refer to FIG. 6A, if the terminal device 110 is approaching the out-of-coverage area, the terminal device 110 may transmit 603, to the access network device 121, first information indicating that the terminal device 110 is approaching the out-of-coverage area. In some embodiments, the terminal device 110 may transmit the first information via a MAC CE. In some embodiments, the terminal device 110 may transmit the first information via a RRC message. In some embodiments, the terminal device 110 may transmit the first information via MsgB in a 2-step RA procedure. In some embodiments, the terminal device 110 may transmit the first information via Msg3 or Msg5 in a 4-step RA procedure. The first information may be designed in a similar way as that described above in connection with FIG. 2 and thus is not repeated here for concise.

With the process 600A, information of approaching an out-of-coverage area may be transmitted in a RA procedure. In this way, a terminal device may also assist a network to handle discontinuous coverage situation. Unnecessary power consumption due to excessive failures or recovery actions may also be avoided.

### EMBODIMENT 2

In this embodiment, information of approaching or not approaching an out-of-coverage area may be reported during a RA procedure. For illustration, this embodiment will be described with reference to FIG. 6B.

FIG. 6B illustrates a schematic diagram illustrating another process 600B for reporting coverage hole information in a RA procedure according to embodiments of the present disclosure. For the purpose of discussion, the process 600B will be described with reference to FIG. 1. The process 600B may involve the terminal device 110 and the access network device 121 as illustrated in FIG. 1.

As shown in FIG. 6B, the access network device 121 may transmit 610, to the terminal device 110, an indication indicating that a coverage hole information reporting in a random access procedure is enabled. That is, the terminal device 110 is enabled to report whether the terminal device 110 is approaching an out-of-coverage area. Alternatively, the coverage hole information reporting may be predefined, and the access network device 121 may not transmit the indication.

In some cases, the terminal device 110 may initiate 611 a RA procedure. For example, the terminal device 110 may transition from an idle or inactive state to a connected state. In response to initiating the RA procedure, the terminal device 110 may determine 612 whether the terminal device 110 is approaching an out-of-coverage area. The operation of the determination 612 is similar to the operation of the determination 220 as described above in connection with FIG. 2, and thus is not repeated here for concise.

Continue to refer to FIG. 6B, if the terminal device 110 is approaching the out-of-coverage area, the terminal device 110 may transmit 613, to the access network device 121, first information indicating that the terminal device 110 is approaching the out-of-coverage area. If the terminal device 110 is not approaching the out-of-coverage area (for example, being away from the out-of-coverage area), the terminal device 110 may transmit 613′, to the access network device 121, second information indicating that the terminal device 110 is not approaching the out-of-coverage area.

In some embodiments, the terminal device 110 may transmit the first or second information via a MAC CE. In some embodiments, the terminal device 110 may transmit the first or second information via a RRC message. In some embodiments, the terminal device 110 may transmit the first or second information via MsgB in a 2-step RA procedure. In some embodiments, the terminal device 110 may transmit the first or second information via Msg3 or Msg5 in a 4-step RA procedure. The first information may be designed in a similar way as that described above in connection with FIG. 2 and thus is not repeated here for concise.

In some embodiments, the second information may comprise an indication (for convenience, also referred to as a second indication herein) of not approaching the out-of-coverage area. In some embodiments, the second information may comprise the period of time before the terminal device 110 enters the out-of-coverage area. In some embodiments, the second information may comprise time information on when the terminal device 110 is going to enter the out-of-coverage area. In some embodiments, the second information may comprise a period of time before the terminal device 110 enters coverage area of a neighbor cell (for example, the cell 124). In some embodiments, the second information may comprise time information on when the terminal device 110 is going to enter coverage area of a neighbor cell (for example, the cell 124). In some embodiments, the second information may comprise a duration for which the terminal device 110 is in the out-of-coverage area.

In some embodiments, the second information may comprise an angle between a moving direction of the access network device 121 and a connecting line between the terminal device 110 and a reference point (e.g., a center of the cell 123). Other details are similar to that described in connection with FIG. 3 and are not repeated here for concise.

In some embodiments, the second information may comprise a serving time range corresponding to the period of time. For example, the first information may indicate that the maximum serving time is greater than first threshold time. As another example, the first information may indicate that the maximum serving time is greater than the first threshold time and is smaller than second threshold time. As still another example, the first information may indicate that the maximum serving time is greater than the second threshold time. It is to be understood that these are merely examples, and the serving time range may adopt any other suitable forms.

It is also to be understood that the second information may also comprise any suitable combination of the above and any other suitable information.

With the process 600B, information of approaching or not approaching an out-of-coverage area may be reported in each RA procedure. In this way, a terminal device may also assist a network to handle discontinuous coverage situation. Unnecessary power consumption due to excessive failures or recovery actions may also be avoided.

### EMBODIMENT 3

In this embodiment, information of approaching an out-of-coverage area may be reported during a PUR transmission. For illustration, this embodiment will be described with reference to FIG. 6C. FIG. 6C illustrates a schematic diagram illustrating a process 600C for reporting coverage hole information in a PUR transmission according to embodiments of the present disclosure. For the purpose of discussion, the process 600C will be described with reference to FIG. 1. The process 600C may involve the terminal device 110 and the access network device 121 as illustrated in FIG. 1.

As shown in FIG. 6C, the terminal device 110 may determine 620 whether the terminal device 110 has a valid PUR resource.

If the terminal device 110 has a valid PUR resource, the terminal device 110 may determine 621 whether the terminal device 110 is approaching an out-of-coverage area. The operation of the determination 621 is similar to the operation of the determination 220 as described above in connection with FIG. 2, and thus is not repeated here for concise.

Continue to refer to FIG. 6C, if the terminal device 110 is approaching the out-of-coverage area, the terminal device 110 may transmit 622, to the access network device 121, first information indicating that the terminal device 110 is approaching the out-of-coverage area. In some embodiments, the terminal device 110 may transmit the first information via a RRCEarlyDataRequest message. In some embodiments, the terminal device 110 may transmit the first information via a RRCConnectionResumeRequest message. The first information may be designed in a similar way as that described above in connection with FIG. 2 and thus is not repeated here for concise.

The access network device 121 may transmit 623 a message to the terminal device 110 to indicate completion of the PUR transmission. For example, the access network device 121 may transmit a Layer 1 acknowledgement (ACK), a TA command, a RRCEarlyDataComplete message or a RRCConnectionRelease message.

With the process 600C, information of approaching an out-of-coverage area may be transmitted in a PUR transmission. In this way, a terminal device may also assist a network to handle discontinuous coverage situation. Unnecessary power consumption due to excessive failures or recovery actions may also be avoided.

As an alternative, the terminal device 110 may transmit the first information in a mobile originated-early data transmission (MO-EDT) procedure. If the terminal device 110 determines to use the MO-EDT procedure, the terminal device 110 may determine whether the terminal device 110 is approaching an out-of-coverage area. The operation of the determination is similar to the operation of the determination 220 as described above in connection with FIG. 2, and thus is not repeated here for concise. If the terminal device 110 is approaching the out-of-coverage area, the terminal device 110 may transmit, to the access network device 121, first information indicating that the terminal device 110 is approaching the out-of-coverage area. In some embodiments, the terminal device 110 may transmit the first information via an RRCEarlyDataRequest message or an RRCConnectionResumeRequest message.

In this way, information of approaching an out-of-coverage area may be transmitted in a MO-EDT procedure. In this way, a terminal device may also assist a network to handle discontinuous coverage situation. Unnecessary power consumption due to excessive failures or recovery actions may also be avoided.

### EMBODIMENT 4

In this embodiment, information of approaching or not approaching an out-of-coverage area may be reported in a PUR transmission. For illustration, this embodiment will be described with reference to FIG. 6D.

FIG. 6D illustrates a schematic diagram illustrating another process 600D for reporting coverage hole information in a PUR transmission according to embodiments of the present disclosure. For the purpose of discussion, the process 600D will be described with reference to FIG. 1. The process 600D may involve the terminal device 110 and the access network device 121 as illustrated in FIG. 1.

As shown in FIG. 6D, when the terminal device 110 is in a connected state and PUR is enabled in the current cell, the terminal device 110 may transmit 630 a PURConfigurationRequest message to the access network device 121.

The access network device 121 may transmit 631, to the terminal device 110, a RRCConnectionRelease message comprising a PUR configuration. The PUR configuration comprises an indication indicating that a coverage hole information reporting in a PUR transmission is enabled. That is, the terminal device 110 is enabled to report whether the terminal device 110 is approaching an out-of-coverage area.

Upon initiation of a RA procedure, the terminal device 110 may determine 632 whether the terminal device 110 has a valid PUR resource.

If the terminal device 110 has a valid PUR resource, the terminal device 110 may determine 633 whether the terminal device 110 is approaching an out-of-coverage area. The operation of the determination 633 is similar to the operation of the determination 220 as described above in connection with FIG. 2, and thus is not repeated here for concise.

Continue to refer to FIG. 6D, if the terminal device 110 is approaching the out-of-coverage area, the terminal device 110 may transmit 634, to the access network device 121, first information indicating that the terminal device 110 is approaching the out-of-coverage area. If the terminal device 110 is not approaching the out-of-coverage area, the terminal device 110 may transmit 634′, to the access network device 121, second information indicating that the terminal device 110 is not approaching the out-of-coverage area. The first information may be designed in a similar way as that described above in connection with FIG. 2 and thus is not repeated here for concise. The second information may be designed in a similar way as that described above in connection with Embodiment 2 and thus is not repeated here for concise.

In some embodiments, the terminal device 110 may transmit the first or second information via a RRCEarlyDataRequest message. In some embodiments, the terminal device 110 may transmit the first or second information via a RRCConnectionResumeRequest message.

In some embodiments where the first information is transmitted, the terminal device 110 does not expect being moved to a connected state. That is, the terminal device 110 does not expect being moved to a connected state when approaching an out-of-coverage area.

The access network device 121 may transmit 635 a message to the terminal device 110 to indicate completion of the PUR transmission. For example, the access network device 121 may transmit a Layer 1 ACK, a TA command, a RRCEarlyDataComplete message or a RRCConnectionRelease message.

With the process 600D, information of approaching or not approaching an out-of-coverage area may be transmitted in a PUR transmission. In this way, a terminal device may also assist a network to handle discontinuous coverage situation. Unnecessary power consumption due to excessive failures or recovery actions may also be avoided.

### Example Implementation of PUR Management

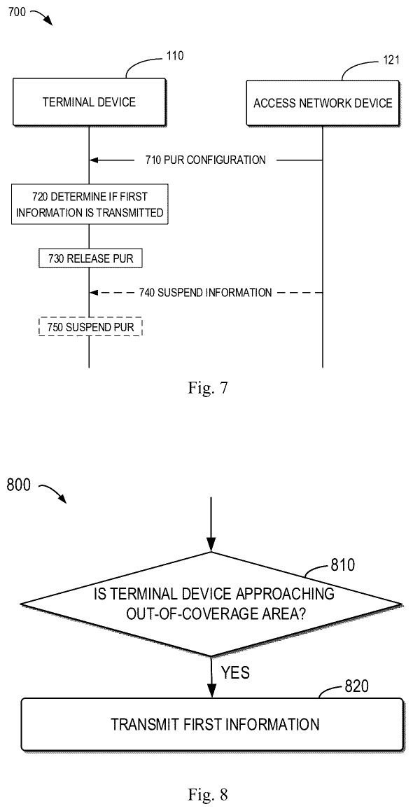

Embodiments of the present disclosure also provide solutions of PUR management. For illustration, these solutions will be described with reference to FIG. 7.

FIG. 7 illustrates a schematic diagram illustrating a process 700 for PUR management according to embodiments of the present disclosure. For the purpose of discussion, the process 700 will be described with reference to FIG. 1. The process 700 may involve the terminal device 110 and the access network device 121 as illustrated in FIG. 1.

As shown in FIG. 7, the access network device 121 may transmit 710 a PUR configuration to the terminal device 110. The transmission of the PUR configuration may be implemented in any suitable ways and the present disclosure does not limit this aspect. The terminal device 110 may determine 720 whether first information is transmitted to indicate that the terminal device 110 is approaching an out-of-coverage area.

If the first information is transmitted, the terminal device 110 may release 730 the PUR. In this way, PUR may be implicitly and immediately released upon reporting of the first information.

In some embodiments, the PUR configuration may indicate that the PUR is released until the first information is transmitted. For example, parameter “pur-NumOccasions” in the PUR configuration may be set to “until coverage hole information reporting”. In these embodiments, the terminal device 110 may release the PUR upon transmission of the first information.

In some embodiments, if the first information is transmitted and the PUR is unused for predetermined times smaller than threshold times, the terminal device 110 may release the PUR. In other words, the terminal device 110 may use a parameter “pur-ImplicitReleaseAfter” with the value shorter than the one used before transmitting the first information. In some embodiments, the value of the parameter “pur-ImplicitReleaseAfter” may be determined by the terminal device 110 based on the one used before transmitting the first information and a configured scaling factor.

In this way, upon entering an out-of-coverage area, a PUR may be implicitly released as PUR may be not used by a terminal device for number of consecutive occasions, and thus excessive consumption of maintaining the PUR may be avoided.

In some embodiments, the access network device 121 may allocate suspend information for PUR. For example, in some embodiments, the access network device 121 may transmit 740 information of a time period for which the PUR is suspended after the transmission of the first information. For example, the access network device 121 may transmit the maximum valid time by considering a load and a satellite orbit. In some embodiments, the terminal device 110 is allowed to use the PUR resources in cells other than the serving cell, in that case, the suspend information also comprise cell identity corresponding to cells in which the terminal device 110 is allowed to use the configured PUR resources.

In some embodiments, the terminal device 110 may not perform PUR transmission and may not release the PUR during the maximum valid time. In some embodiments, the terminal device 110 may use the same PUR in the next serving duration by this satellite.

In some embodiments, the suspend information for PUR may be allocated during a PUR configuration. In some embodiments, the suspend information for PUR may be allocated during completion of a PUR transmission. In some embodiments, the suspend information for PUR may be allocated during a PUR configuration and may be enabled during completion of a PUR transmission.

Continue to refer to FIG. 7, upon reception of the suspend information, the terminal device 110 may suspend 750 the PUR for the configured time period in response to transmitting the first information. For example, upon transmission of the first information, the terminal device 110 may start a timer set to the maximum valid time. Upon expiry of the timer, the access network device 121 and the terminal device 110 may consider that the PUR resources is available again. In that case, the access network device 121 and the terminal device 110 may continue to a counting for the case “PUR has not been used” and explicit release the PUR resources upon reaching “pur-ImplicitReleaseAfter” times. In some embodiments, the access network device 121 may allocate the same PUR to other terminal devices when the PUR is considered as suspend. In this way, utilization of PUR may be optimized.

It is to be understood that the above embodiments described in connection with FIGS. 2 to 7 may be carried out separately or in any suitable combination.

### Example Implementation of Methods

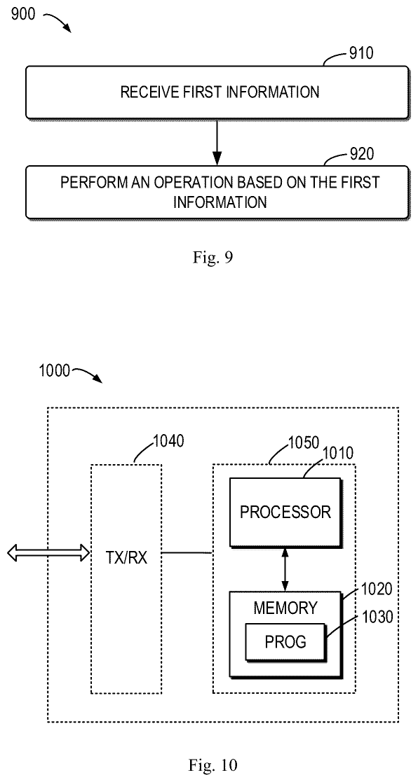

Accordingly, embodiments of the present disclosure provide methods of communication implemented at a terminal device and an access network device. These methods will be described below with reference to FIGS. 8 to 9.

FIG. 8 illustrates an example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 determines whether the terminal device 110 is approaching an out-of-coverage area based on a period of time before the terminal device 110 enters the out-of-coverage area. If the terminal device 110 is approaching the out-of-coverage area, the method 800 proceeds to block 820.

At block 820, the terminal device 110 transmits first information indicating that the terminal device 110 is approaching the out-of-coverage area.

In some embodiments, if the period of time is smaller than a threshold, the terminal device 110 may determine that the terminal device 110 is approaching the out-of-coverage area. If the period of time is greater than the threshold, the terminal device 110 may determine that the terminal device 110 is not approaching the out-of-coverage area.

In some embodiments, the first information may comprise at least one of the following: a first indication of approaching the out-of-coverage area; the period of time before the terminal device enters the out-of-coverage area; time information on when the terminal device is going to enter the out-of-coverage area; a period of time before the terminal device enters coverage area of a neighbor cell; time information on when the terminal device is going to enter coverage area of a neighbor cell; a duration for which the terminal device is in the out-of-coverage area; an angle between a moving direction of a non-terrestrial network node and a connecting line between the terminal device and a reference point; or a serving time range corresponding to the period of time.

In some embodiments, if the terminal device 110 is not approaching the out-of-coverage area, the terminal device 110 may transmit second information indicating that the terminal device 110 is not approaching the out-of-coverage area.

In some embodiments, the second information may comprise at least one of the following: a second indication of not approaching the out-of-coverage area; the period of time before the terminal device enters the out-of-coverage area; time information on when the terminal device is going to enter the out-of-coverage area; a period of time before the terminal device enters coverage area of a neighbor cell; time information on when the terminal device is going to enter coverage area of a neighbor cell; a duration for which the terminal device is in the out-of-coverage area; an angle between a moving direction of a non-terrestrial network node and a connecting line between the terminal device and a reference point; or a serving time range corresponding to the period of time.

In some embodiments, the terminal device 110 may receive a configuration of transmitting the first information.

In some embodiments, the terminal device 110 may receive an indication indicating that triggering a scheduling request is enabled for the transmission of the first information. If no resources are available for the transmission of the first information, the terminal device 110 may trigger the scheduling request.

In some embodiments, if a radio link failure is detected and the first information is transmitted, the terminal device 110 may leave a connected state. In some embodiments, if the first information is transmitted, the terminal device 110 may start a data inactivity timer having a value smaller than a threshold value. In some embodiments, if the first information is transmitted, the terminal device 110 may stop at least one of intra-frequency measurements or inter-frequency measurements.

In some embodiments, if information of timing advance is to be reported, the terminal device 110 may determine whether the terminal device is approaching the out-of-coverage area. In some embodiments, if the terminal device is not approaching the out-of-coverage area, the terminal device 110 may report the information of timing advance. In some embodiments, if the terminal device is approaching the out-of-coverage area, the terminal device 110 may transmit the first information with the information of timing advance.

In some embodiments, the terminal device 110 may transmit the first information in a random access procedure.

In some embodiments, the terminal device 110 may receive an indication indicating that transmission of the first or second information in a random access procedure is enabled; and transmit the first or second information in the random access procedure. In some embodiments, the terminal device 110 may receive the indication in a configuration of a preconfigured uplink resource.

In some embodiments, the terminal device 110 may receive a configuration of a preconfigured uplink resource. If the first information is transmitted, the terminal device 110 may release the preconfigured uplink resource. In some embodiments, the configuration of the preconfigured uplink resource may indicate that the preconfigured uplink resource is released until the first information is transmitted.

In some embodiments, the terminal device 110 may receive a configuration of a preconfigured uplink resource. If the first information is transmitted and the preconfigured uplink resource is unused for predetermined times smaller than threshold times, the terminal device 110 may release the preconfigured uplink resource.

In some embodiments, the terminal device 110 may receive a configuration of a preconfigured uplink resource and receive information of a time period for which the preconfigured uplink resource is suspended after the transmission of the first information. If the first information is transmitted, the terminal device 110 may suspend the preconfigured uplink resource for the time period.

With the method 800, a terminal device may assist a network to handle discontinuous coverage situation. Unnecessary power consumption due to excessive failures or recovery actions may be avoided.

FIG. 9 illustrates an example method 900 of communication implemented at an access network device in accordance with some embodiments of the present disclosure. For example, the method 900 may be performed at the access network device 121 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the access network device 121 receives first information indicating that the terminal device 110 is approaching an out-of-coverage area.

At block 920, the access network device 121 performs an operation based on the first information.

In some embodiments, the access network device 121 may release the terminal device 110 before the terminal device 110 enters the out-of-coverage area. In some embodiments, the access network device 121 may skip reaching the terminal device when the terminal device is in the out-of-coverage area. In some embodiments, the access network device 121 may transmit the first information to a core network device.

In some embodiments, the first information comprises at least one of the following: a first indication of approaching the out-of-coverage area; the period of time before the terminal device enters the out-of-coverage area; time information on when the terminal device is going to enter the out-of-coverage area; a period of time before the terminal device enters coverage area of a neighbor cell; time information on when the terminal device is going to enter coverage area of a neighbor cell; a duration for which the terminal device is in the out-of-coverage area; an angle between a moving direction of a non-terrestrial network node and a connecting line between the terminal device and a reference point; or a serving time range corresponding to the period of time.

In some embodiments, the access network device 121 may receive second information indicating that the terminal device is not approaching the out-of-coverage area.

In some embodiments, the second information may comprise at least one of the following: a second indication of not approaching the out-of-coverage area; the period of time before the terminal device enters the out-of-coverage area; time information on when the terminal device is going to enter the out-of-coverage area; a period of time before the terminal device enters coverage area of a neighbor cell; time information on when the terminal device is going to enter coverage area of a neighbor cell; a duration for which the terminal device is in the out-of-coverage area; an angle between a moving direction of a non-terrestrial network node and a connecting line between the terminal device and a reference point; or a serving time range corresponding to the period of time.

In some embodiments, the access network device 121 may transmit a configuration of transmitting the first information.

In some embodiments, the access network device 121 may transmit an indication indicating that triggering a scheduling request is enabled for transmission of the first information.

In some embodiments, the access network device 121 may receive the first information with information of timing advance.

In some embodiments, the access network device 121 may receive the first information in a random access procedure.

In some embodiments, the access network device 121 may transmit an indication indicating that transmission of the first or second information in a random access procedure is enabled, and receive the first or second information in the random access procedure. In some embodiments, the access network device 121 may transmit the indication in a configuration of a preconfigured uplink resource.

In some embodiments, the access network device 121 may transmit a configuration of a preconfigured uplink resource. If the first information is received, the access network device 121 may release the preconfigured uplink resource.

In some embodiments, the configuration of the preconfigured uplink resource may indicate that the preconfigured uplink resource is released until the first information is transmitted.

In some embodiments, the access network device 121 may transmit a configuration of a preconfigured uplink resource. If the first information is received and the preconfigured uplink resource is unused for predetermined times smaller than threshold times, the access network device 121 may release the preconfigured uplink resource.

In some embodiments, the access network device 121 may transmit a configuration of a preconfigured uplink resource and transmit information of a time period for which the preconfigured uplink resource is suspended after the transmission of the first information. If the first information is received, the access network device 121 may suspend the preconfigured uplink resource for the time period.

With the method 900, coverage hole information reporting may be configured to a terminal device and coverage hole information may be used to handle discontinuous coverage situation. Unnecessary power consumption due to excessive failures or recovery actions may be avoided.

### Example Implementation of Device and Apparatus

FIG. 10 is a simplified block diagram of a device 1000 that is suitable for implementing embodiments of the present disclosure. The device 1000 can be considered as a further example implementation of the terminal device 110 or the access network device 121 as shown in FIG. 1. Accordingly, the device 1000 can be implemented at or as at least a part of the terminal device 110 or the access network device 121.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: determine whether the terminal device is approaching an out-of-coverage area based on a period of time before the terminal device enters the out-of-coverage area; and in accordance with a determination that the terminal device is approaching the out-of-coverage area, transmit first information indicating that the terminal device is approaching the out-of-coverage area.

In some embodiments, an access network device comprises a circuitry configured to: receive first information indicating that a terminal device is approaching an out-of-coverage area; and perform an operation based on the first information.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

Clause 1. A method of communication, comprising:
determining, at a terminal device, whether the terminal device is approaching an out-of-coverage area based on a period of time before the terminal device enters the out-of-coverage area; and
in accordance with a determination that the terminal device is approaching the out-of-coverage area, transmitting first information indicating that the terminal device is approaching the out-of-coverage area.

Clause 2. The method of Clause 1, wherein determining whether the terminal device is approaching the out-of-coverage area comprises:
in accordance with a determination that the period of time is smaller than a threshold, determining that the terminal device is approaching the out-of-coverage area; and
in accordance with a determination that the period of time is greater than the threshold, determining that the terminal device is not approaching the out-of-coverage area.

Clause 3. The method of Clause 1, wherein the first information comprises at least one of the following:
a first indication of approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

Clause 4. The method of Clause 1, further comprising:
in accordance with a determination that the terminal device is not approaching the out-of-coverage area, transmitting second information indicating that the terminal device is not approaching the out-of-coverage area.

Clause 5. The method of Clause 4, wherein the second information comprises at least one of the following:
a second indication of not approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

Clause 6. The method of Clause 1, further comprising:
receiving a configuration of transmitting the first information.

Clause 7. The method of Clause 1, wherein transmitting the first information comprises:
receiving an indication indicating that triggering a scheduling request is enabled for the transmitting of the first information; and
in accordance with a determination that no resources are available for the transmitting of the first information, triggering the scheduling request.

Clause 8. The method of Clause 1, further comprising at least one of the following:
in accordance with a determination that a radio link failure is detected and the first information is transmitted, leaving a connected state;
in accordance with a determination that the first information is transmitted, starting a data inactivity timer having a value smaller than a threshold value; or
in accordance with a determination that the first information is transmitted, stopping at least one of intra-frequency measurements or inter-frequency measurements.

Clause 9. The method of Clause 1, wherein determining whether the terminal device is approaching the out-of-coverage area comprises:
in accordance with a determination that information of timing advance is to be reported, determining whether the terminal device is approaching the out-of-coverage area.

Clause 10. The method of Clause 9, further comprising:
in accordance with a determination that the terminal device is not approaching the out-of-coverage area, reporting the information of timing advance.

Clause 11. The method of Clause 9, wherein transmitting the first information comprises:
transmitting the first information with the information of timing advance.

Clause 12. The method of Clause 1, wherein transmitting the first information comprises:
transmitting the first information in a random access procedure.

Clause 13. The method of Clause 4, further comprising:
receiving an indication indicating that transmission of the first or second information in a random access procedure is enabled; and
wherein transmitting the first or second information comprises:
transmitting the first or second information in the random access procedure.

Clause 14. The method of Clause 13, wherein receiving the indication comprises:
receiving the indication in a configuration of a preconfigured uplink resource.

Clause 15. The method of Clause 1, further comprising:
receiving a configuration of a preconfigured uplink resource; and
in accordance with a determination that the first information is transmitted, releasing the preconfigured uplink resource.

Clause 16. The method of Clause 15, wherein the configuration of the preconfigured uplink resource indicates that the preconfigured uplink resource is released until the first information is transmitted.

Clause 17. The method of Clause 1, further comprising:
receiving a configuration of a preconfigured uplink resource; and
in accordance with a determination that the first information is transmitted and the preconfigured uplink resource is unused for predetermined times smaller than threshold times, releasing the preconfigured uplink resource.

Clause 18. The method of Clause 1, further comprising:
receiving a configuration of a preconfigured uplink resource;
receiving information of a time period for which the preconfigured uplink resource is suspended after the transmitting of the first information; and
in accordance with a determination that the first information is transmitted, suspending the preconfigured uplink resource for the time period.

Clause 19. A method of communication, comprising:
receiving, at an access network device, first information indicating that a terminal device is approaching an out-of-coverage area; and
performing an operation based on the first information.

Clause 20. The method of Clause 19, wherein performing the operation comprises at least one of the following:
releasing the terminal device before the terminal device enters the out-of-coverage area;
skipping reaching the terminal device when the terminal device is in the out-of-coverage area; or
transmitting the first information to a core network device.

Clause 21. The method of Clause 19, wherein the first information comprises at least one of the following:
a first indication of approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

Clause 22. The method of Clause 19, further comprising:
receiving second information indicating that the terminal device is not approaching the out-of-coverage area.

Clause 23. The method of Clause 22, wherein the second information comprises at least one of the following:
a second indication of not approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

Clause 24. The method of Clause 19, further comprising:
transmitting a configuration of transmitting the first information.

Clause 25. The method of Clause 19, further comprising:
transmitting an indication indicating that triggering a scheduling request is enabled for transmission of the first information.

Clause 26. The method of Clause 19, wherein receiving the first information comprises:
receiving the first information with information of timing advance.

Clause 27. The method of Clause 19, wherein receiving the first information comprises:
receiving the first information in a random access procedure.

Clause 28. The method of Clause 22, further comprising:
transmitting an indication indicating that transmission of the first or second information in a random access procedure is enabled; and
wherein receiving the first or second information comprises:
receiving the first or second information in the random access procedure.

Clause 29. The method of Clause 28, wherein transmitting the indication comprises:
transmitting the indication in a configuration of a preconfigured uplink resource.

Clause 30. The method of Clause 19, further comprising:
transmitting a configuration of a preconfigured uplink resource; and
in accordance with a determination that the first information is received, releasing the preconfigured uplink resource.

Clause 31. The method of Clause 30, wherein the configuration of the preconfigured uplink resource indicates that the preconfigured uplink resource is released until the first information is transmitted.

Clause 32. The method of Clause 19, further comprising:
transmitting a configuration of a preconfigured uplink resource; and
in accordance with a determination that the first information is received and the preconfigured uplink resource is unused for predetermined times smaller than threshold times, releasing the preconfigured uplink resource.

Clause 33. The method of Clause 19, further comprising:
transmitting a configuration of a preconfigured uplink resource;
transmitting information of a time period for which the preconfigured uplink resource is suspended after the transmission of the first information; and
in accordance with a determination that the first information is received, suspending the preconfigured uplink resource for the time period.

Clause 34. A terminal device comprising:
a processor configured to perform the method according to any of Clauses 1-18.

Clause 35. An access network device comprising:
a processor configured to perform the method according to any of Clauses 19-33.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a terminal device, whether the terminal device is approaching an out-of-coverage area based on a period of time before the terminal device enters the out-of-coverage area; and
in accordance with a determination that the terminal device is approaching the out-of-coverage area, transmitting first information indicating that the terminal device is approaching the out-of-coverage area.

2. The method of claim 1, wherein determining whether the terminal device is approaching the out-of-coverage area comprises:
in accordance with a determination that the period of time is smaller than a threshold, determining that the terminal device is approaching the out-of-coverage area; and
in accordance with a determination that the period of time is greater than the threshold, determining that the terminal device is not approaching the out-of-coverage area.

3. The method of claim 1, wherein the first information comprises at least one of the following:
a first indication of approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

4. The method of claim 1, further comprising:
in accordance with a determination that the terminal device is not approaching the out-of-coverage area, transmitting second information indicating that the terminal device is not approaching the out-of-coverage area.

5. The method of claim 4, wherein the second information comprises at least one of the following:
a second indication of not approaching the out-of-coverage area;
the period of time before the terminal device enters the out-of-coverage area;
time information on when the terminal device is going to enter the out-of-coverage area;
a period of time before the terminal device enters coverage area of a neighbor cell;
time information on when the terminal device is going to enter coverage area of a neighbor cell;
a duration for which the terminal device is in the out-of-coverage area;
an angle between a moving direction of a non-terrestrial network node and a connecting line between the terminal device and a reference point; or
a serving time range corresponding to the period of time.

6. The method of claim 1, further comprising:
receiving a configuration of transmitting the first information.

7. The method of claim 1, wherein transmitting the first information comprises:
receiving an indication indicating that triggering a scheduling request is enabled for the transmitting of the first information; and
in accordance with a determination that no resources are available for the transmitting of the first information, triggering the scheduling request.

8. The method of claim 1, further comprising at least one of the following:
in accordance with a determination that a radio link failure is detected and the first information is transmitted, leaving a connected state;
in accordance with a determination that the first information is transmitted, starting a data inactivity timer having a value smaller than a threshold value; or
in accordance with a determination that the first information is transmitted, stopping at least one of intra-frequency measurements or inter-frequency measurements.

9. The method of claim 1, wherein determining whether the terminal device is approaching the out-of-coverage area comprises:
in accordance with a determination that information of timing advance is to be reported, determining whether the terminal device is approaching the out-of-coverage area.

10. The method of claim 9, further comprising:
in accordance with a determination that the terminal device is not approaching the out-of-coverage area, reporting the information of timing advance.

11. The method of claim 9, wherein transmitting the first information comprises:
transmitting the first information with the information of timing advance.

12. The method of claim 1, wherein transmitting the first information comprises:
transmitting the first information in a random access procedure.

13. The method of claim 4, further comprising:
receiving an indication indicating that transmission of the first or second information in a random access procedure is enabled; and
wherein transmitting the first or second information comprises:
transmitting the first or second information in the random access procedure.

14. The method of claim 13, wherein receiving the indication comprises:
receiving the indication in a configuration of a preconfigured uplink resource.

15. The method of claim 1, further comprising:
receiving a configuration of a preconfigured uplink resource; and
in accordance with a determination that the first information is transmitted, releasing the preconfigured uplink resource.

16. The method of claim 15, wherein the configuration of the preconfigured uplink resource indicates that the preconfigured uplink resource is released until the first information is transmitted.

17. The method of claim 1, further comprising:
receiving a configuration of a preconfigured uplink resource; and
in accordance with a determination that the first information is transmitted and the preconfigured uplink resource is unused for predetermined times smaller than threshold times, releasing the preconfigured uplink resource.

18. The method of claim 1, further comprising:
receiving a configuration of a preconfigured uplink resource;
receiving information of a time period for which the preconfigured uplink resource is suspended after the transmitting of the first information; and
in accordance with a determination that the first information is transmitted, suspending the preconfigured uplink resource for the time period.

19. A method of communication, comprising:
receiving, at an access network device, first information indicating that a terminal device is approaching an out-of-coverage area; and
performing an operation based on the first information.

20. A device of communication comprising:
a processor configured to perform the method according to claim 1.
